(19) United States
(12) Patent Application Publication
(10) Pub. No.: US 2015/0096769 A1
(43) Pub. Date: Apr. 9, 2015

(54) FIRE EXTINGUISHING NOZZLE AND FIRE EXTINGUISHING METHOD USING THE SAME

(71) Applicant: NGK Insulators, Ltd., Nagoya-City (JP)

(72) Inventor: Motohiro FUKUHARA, Nagoya-City (JP)

(21) Appl. No.: 14/561,370

(22) Filed: Dec. 5, 2014

Related U.S. Application Data
(63) Continuation of application No. PCT/JP2013/067534, filed on Jun. 26, 2013.

(30) Foreign Application Priority Data
Jul. 13, 2012 (JP) 2012-157258

(51) Int. Cl. A62C 31/02; A62C 99/00; A62C 3/16

(52) U.S. Cl. CPC A62C 31/02; A62C 3/16; A62C 99/0045
USPC 169/46; 169/70

(57) ABSTRACT

The present invention relates to a technique of emitting fire extinguishing sand on an upper surface of a fire extinguishing object such as an assembled battery housed in a rack in a multistage manner by means of gas pressure to extinguish fire. In the present invention, a tip end portion of a flattened nozzle main body 12 is provided with a deflecting plate 16, and by spraying the fire extinguishing sand obliquely downward and letting the fire extinguishing sand bound, the fire extinguishing sand is dispersed on the entire upper surface uniformly.

### TECHNICAL FIELD

The present invention relates to a fire extinguishing nozzle suitable for fire extinction for a fire extinguishing object having a flattened upper space such as a battery module case housing an assembled battery and a fire extinguishing method using the same.

### BACKGROUND ART

A battery system using an assembled battery is constituted by combination of multiple battery modules each housing hundreds of battery cells in a thermal insulating enclosure. These battery modules are housed in an inside of a rack in a multistage manner, and in a case of a general five-stage stack, the height from a floor surface (a ground surface) to the uppermost stage reaches approximately 5 m. Additionally, to set an installing space as small as possible, the height of each stage of the rack is set to be slightly longer than the height of the battery module, and thus an upper space of the battery module is no more than several centimeters or so in height. However, the upper space is a flattened space having a depth and a width of approximately 2 m.

In case of firing of such a battery module, fire may spread to the battery modules housed in a multistage manner one after another and be enlarged. In a case of using sodium-sulfur batteries as the assembled battery, hot molten material of sodium and sulfur blows out to an upper surface of the thermal insulating enclosure, and when the hot molten material contacts air, a severe oxidation reaction occurs, which may cause enlargement of the fire. Since fire extinction with water is impossible due to existence of sodium, fire extinction by suffocation, in which air is shut off with fire extinguishing sand, is required; however, it is not easy to emit the fire extinguishing sand so as to fill the flattened upper space at a high upper stage as described above. That is, when emitting speed is too high, the fire extinguishing sand goes over an upper surface of the battery module as a fire extinguishing object and cannot cover the upper surface of the battery module uniformly. On the other hand, when the emitting speed is lowered to the extent that the fire extinguishing sand does not go over it, a nozzle is clogged with the fire extinguishing sand. Accordingly, effective fire extinction has not been able to be achieved.

Patent Document 1 filed by the present applicant describes a fire extinguishing apparatus adapted to spray ceramic particles to a fire extinguishing object. However, this document does not disclose a structure of a nozzle part, and no means for solving the above problems seems to exist conventionally.

### PRIOR ART DOCUMENENT

### Patent Document

Patent Document 1: JP 06-269509 A

### DISCLOSURE OF THE INVENTION

### Problems to be Solved by the Invention

An object of the present invention is to solve the aforementioned conventional problems and to provide a fire extinguishing nozzle capable of dispersing fire extinguishing sand uniformly to an entire upper surface of a fire extinguishing object having a flattened upper space to extinguish fire and a fire extinguishing method using the same.

### Solutions to the Problems

To solve the above problems, a fire extinguishing nozzle according to the present invention is a fire extinguishing nozzle for emitting fire extinguishing sand uniformly on an upper surface of a fire extinguishing object having a flattened upper space. The fire extinguishing nozzle comprises a flattened nozzle main body emitting the fire extinguishing sand by means of gas pressure and a deflecting plate, provided at a tip end portion of the flattened nozzle main body, spraying the fire extinguishing sand obliquely downward toward the upper surface of the fire extinguishing object and letting the fire extinguishing sand bound.

Meanwhile, as in claim 2, a lower surface of the flattened nozzle main body is preferably provided with a guide plate having a recess for positioning the nozzle main body. Also, as in claim 3, the deflecting plate preferably has a downward angle of 30 to 45 degrees against the upper surface of the fire extinguishing object. Further, as in claim 4, a base portion of the nozzle main body can be bent obliquely downward, and a lower end thereof can be provided with a connecting portion to a metallic pipe supplying the fire extinguishing sand by means of the gas pressure.

Also, a fire extinguishing method according to the present invention is a fire extinguishing method using the fire extinguishing nozzle according to claim 1 and includes inserting the nozzle main body from an end of the flattened upper space formed on the upper surface of the fire extinguishing object to an end portion of the upper surface of the fire extinguishing object, spraying the fire extinguishing sand emitted from the tip end portion of the nozzle main body by means of the gas pressure obliquely downward by the deflecting plate, and dispersing the fire extinguishing sand through a back side while letting the fire extinguishing sand bound on the upper surface of the fire extinguishing object. Meanwhile, as in claim 6, the fire extinguishing sand is preferably vermiculite.

### Effects of the Invention

With the fire extinguishing nozzle according to the present invention, the fire extinguishing sand is sprayed obliquely downward toward the upper surface of the fire extinguishing object by the deflecting plate provided at the tip end portion of the flattened nozzle main body and goes forward while bounding in the flattened upper space. The fire extinguishing sand is then sequentially deposited from a position at which the fire extinguishing sand has been deposited to the near side, is eventually dispersed over the entire upper surface of the fire extinguishing object in a uniform manner, and forms an air blocking layer. Accordingly, fire extinction for the fire extinguishing object having the flattened upper space can be performed.

As in claim 2, since the lower surface of the flattened nozzle main body is provided with the guide plate having the recess for positioning the nozzle main body, the nozzle main body can be positioned reliably in the flattened upper space of the fire extinguishing object which cannot be visually checked directly since the fire extinguishing object is located at a high position.

As in claim 3, since the deflecting plate has the downward angle of 30 to 45 degrees against the upper surface of the fire extinguishing object, the aforementioned bounding of the fire extinguishing sand can be performed reliably.

As in claim 4, since the base portion of the nozzle main body is bent obliquely downward, and the lower end thereof is provided with the connecting portion to the metallic pipe supplying the fire extinguishing sand by means of the gas pressure, a case in which a firing source is located at a high position can be coped with by connecting the metallic pipe.

Also, with the fire extinguishing method according to the present invention, the fire extinguishing sand can be dispersed over the entire upper surface of the fire extinguishing object in a uniform manner while bounding in the flattened upper space, and air is blocked by the fire extinguishing sand to enable reliable fire extinction.

Further, as in claim 6, since the fire extinguishing sand is the vermiculite, and nitrogen gas is used as actuating gas for an ejector, an air blocking effect due to the nitrogen gas is exerted as well, and a more reliable fire extinguishing effect can be obtained.

### BRIEF DESCRIPTION OF THE DRAWINGS

FIG. 1 is a front view of a battery charge system of sodium-sulfur batteries.

FIG. 2 is a vertical cross-sectional view of the battery charge system of the sodium-sulfur batteries.

FIG. 3 is a perspective view of a battery module.

FIG. 4 is a plan view and a front view of a fire extinguishing nozzle according to the present invention.

FIG. 5 describes a main part illustrating a usage state.

### EMBODIMENTS OF THE INVENTION

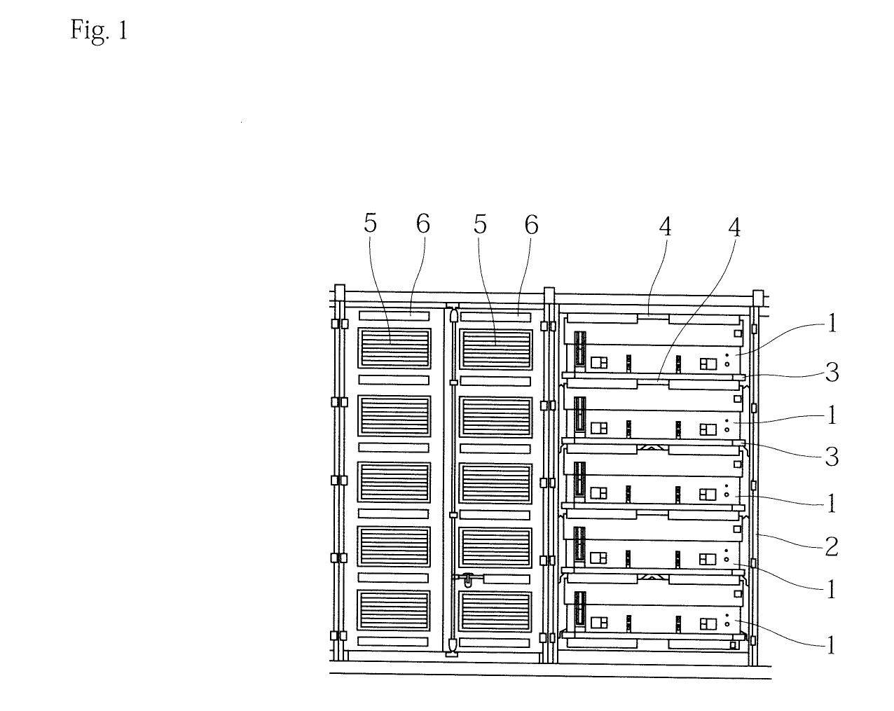

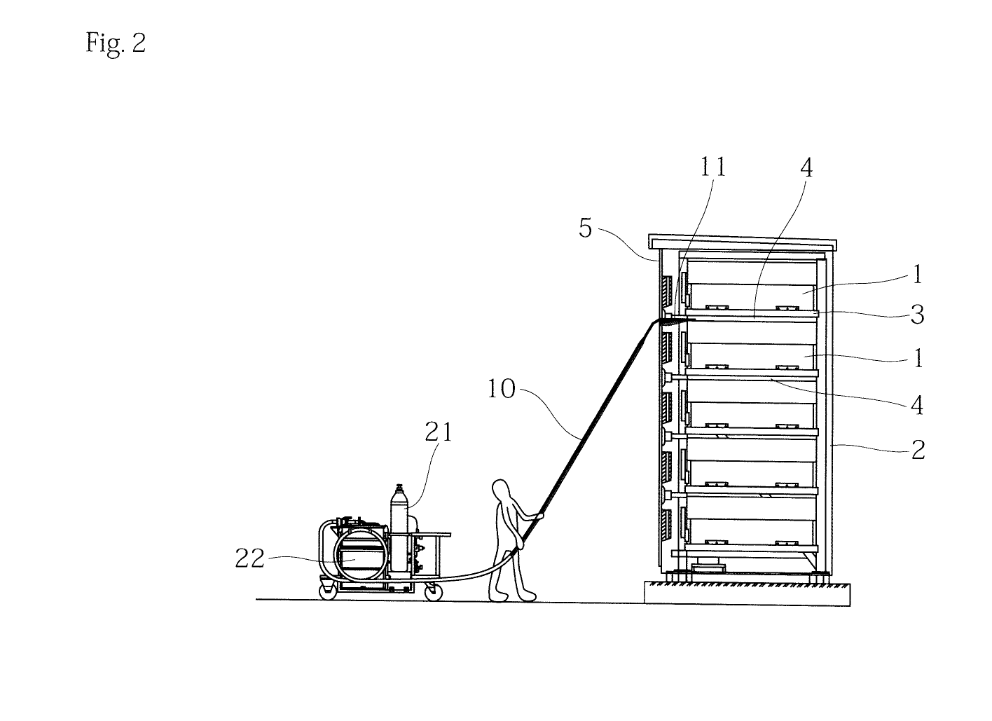

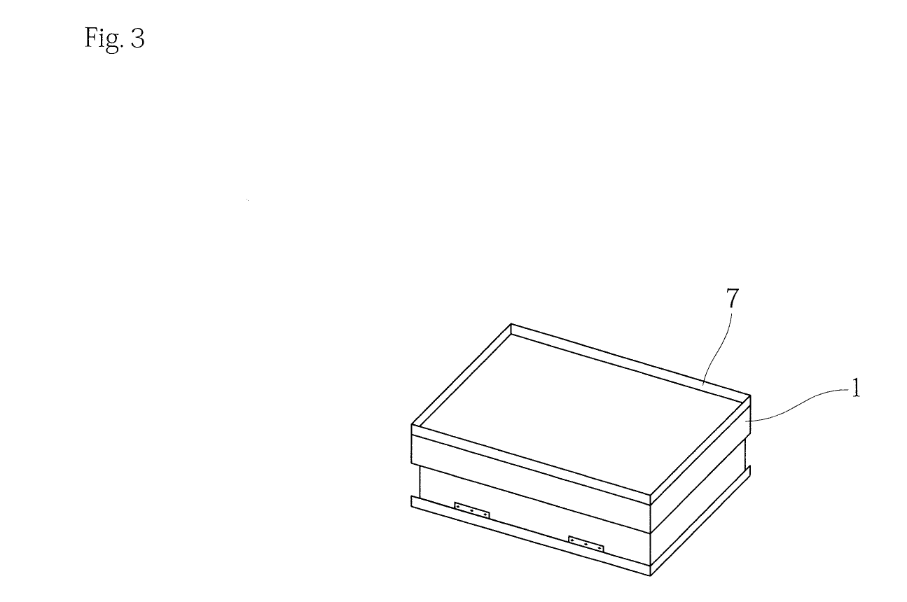

Hereinbelow, preferred embodiments of the present invention will be described. In the following embodiments, a fire extinguishing object is a battery system of sodium-sulfur batteries, FIG. 1 is a front view of a battery charge system of sodium-sulfur batteries, FIG. 2 is a vertical cross-sectional view thereof, and FIG. 3 is a perspective view of a battery module.

In these figures, reference sign 1 denotes a battery module, which houses multiple sodium-sulfur battery cells in an inside of a thermal insulating enclosure as described above. The battery system using the sodium-sulfur batteries is constituted by combination of the multiple battery modules 1 in accordance with the charging capacity. Each of the battery modules 1 is a rectangular solid having a width and a depth of approximately 2 m and a height of approximately 1 m, and the battery modules 1 are housed in a rack 2 having a total height of nearly 5 m in a multistage manner. A flattened upper space 4 having a height of no more than 5 cm or so is formed between a floor plate 3 of the rack 2 and an upper surface of the battery module 1. Meanwhile, doors 5 are arranged on a front face of the rack 2, and horizontally long openings 6 are formed at positions corresponding to the respective upper spaces 4 as illustrated in the figures. These openings 6 may be opened at all times but can be in a punch-out structure enabling the openings 6 to be broken easily in case of fire. Also, as illustrated in FIG. 3, on a rim of the upper surface of the battery module 1, a frame 7 having a height of 3 cm or so is provided to project over the entire circumference.

As illustrated in FIG. 2, as many metallic pipes 10 as the appropriate number are connected to one another in accordance with the height of a firing source, a fire extinguishing nozzle 11 attached to a tip end of the metallic pipe 10 is inserted into the opening 6 of the door 5, and fire extinguishing sand is emitted into the upper space 4. As the fire extinguishing sand, expanded vermiculite, which is permitted under the Fire Service Act, is preferably used. The expanded vermiculite has low specific gravity and has a feature of expanding and forming an air blocking layer when heat is applied. Based on an experiment, depositing the vermiculite as high as about 3 cm can bring about a sufficient fire extinguishing effect. A particle diameter of the fire extinguishing sand is preferably about 3 to 5 mm. The reason for this is that the sand with a shorter or longer particle diameter than it may cause clogging since the fire extinguishing sand is sucked in a vacuum ejector method in the present invention. Also, as a pressure source, nitrogen gas is preferably used.

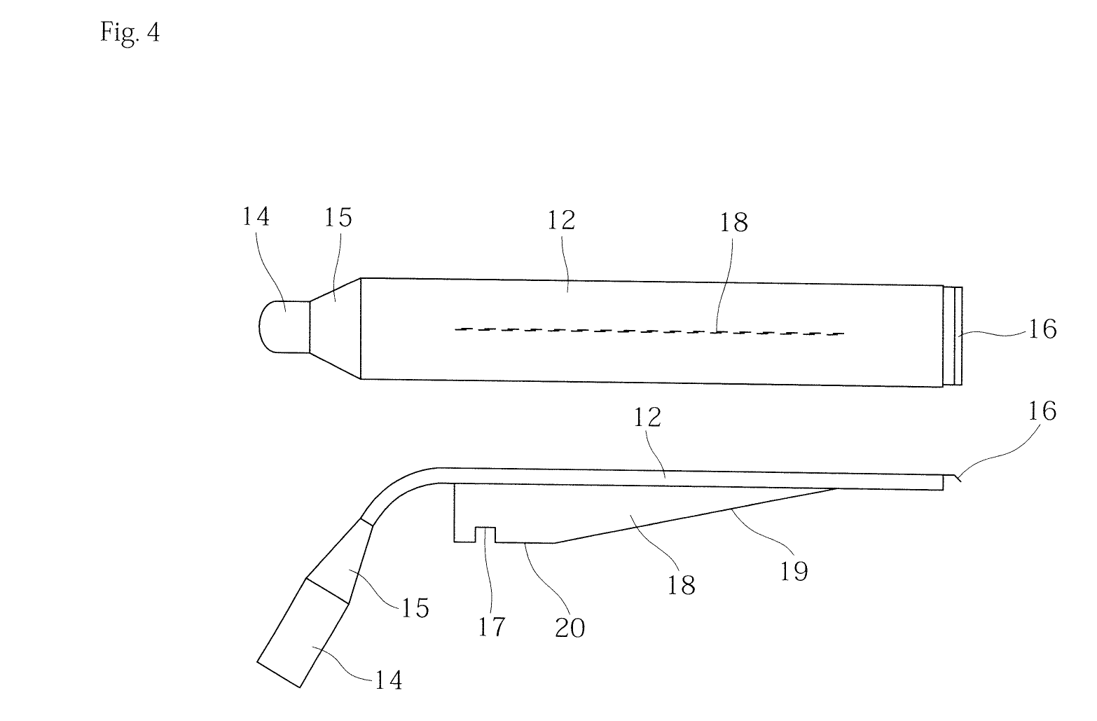

FIG. 4 illustrates a structure of the fire extinguishing nozzle according to the present invention. A nozzle main body 12 is in a flat plate shape having a flattened internal space having a thickness of 15 mm or so, a rear end part thereof is bent obliquely downward, and a lower end thereof is provided with a connecting portion 14 to the metallic pipe 10. This connecting portion 14 is bent downward at an angle of 120 degrees against the nozzle main body 12. Also, between the nozzle main body 12 and the connecting portion 14, a coupling portion 15 having a flat-plate-like tip end and a circular base end is provided. All of these parts are preferably made of heat-resistant stainless steel.

A tip end of the nozzle main body 12 is provided with a deflecting plate 16 over an entire width as illustrated in FIG. 4. This deflecting plate 16 is adapted to change a traveling direction of the fire extinguishing sand to be emitted from the tip end of the nozzle main body 12 and spray the fire extinguishing sand obliquely downward toward the upper surface of the fire extinguishing object. The fire extinguishing sand travels in a depth direction while bounding on the upper surface of the fire extinguishing object, is held by the frame 7 (frame on the rear side) provided to project on the rim of the upper surface of the fire extinguishing object, and is deposited on the upper surface on the back side. Since the deposited fire extinguishing sand holds the fire extinguishing sand emitted subsequently, the fire extinguishing sand is sequentially deposited from the back side to the near side of the fire extinguishing object, and a sand layer having a thickness of 3 cm or so is eventually formed over the entire upper surface of the fire extinguishing object in a uniform manner. Such a depositing condition has been confirmed in an experiment. Meanwhile, as described above, the fire extinguishing sand goes out in a horizontal direction and goes over the upper surface of the fire extinguishing object in a case in which no deflecting plate 16 is provided while the nozzle is clogged with the fire extinguishing sand when the emitting speed is lowered to prevent the fire extinguishing sand from going over it.

The deflecting plate 16 is foiined at a downward angle of 30 to 45 degrees against the upper surface of the fire extinguishing object. When this angle is smaller than 30 degrees, the emitting angle is close to a horizontal position, and the fire extinguishing sand is easy to go over the upper surface of the fire extinguishing object. On the other hand, when the angle is larger than 45 degrees, the fire extinguishing sand is deposited at an exit of the nozzle and is difficult to reach the back side on the upper surface of the fire extinguishing object. Meanwhile, since the opening 6 of the door 5 extends in a right-left direction, the nozzle main body 12 can be moved from side to side through a manual operation, and the fire extinguishing sand can be dispersed uniformly in the right-left direction as well.

As illustrated in FIG. 2, in a case in which the firing source is located at a high position, a worker on the ground cannot visually check the nozzle main body 12, and thus it is not easy to stabilize the nozzle main body 12 at a predetermined position. To cope with this, in the present embodiment, a lower surface of the flattened nozzle main body 12 is provided with a guide plate 18 having a positioning recess 17. This guide plate 18 is formed in a flat plate shape, includes an inclined portion 19 on a tip end side and a horizontal portion 20 on a rear side of the inclined portion 19, and the rectangular positioning recess 17 is formed at this horizontal portion 20. A width of this positioning recess 17 is larger than a plate thickness of the aforementioned door 5.

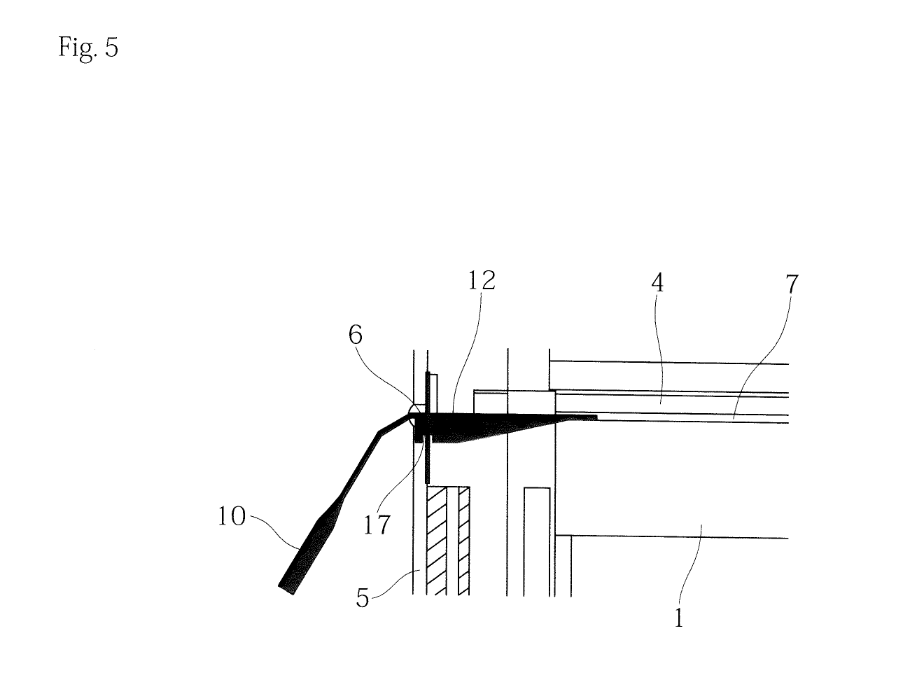

Thus, by inserting the tip end of the nozzle main body 12 into the opening 6 of the door 5 corresponding to the firing source and then pushing the nozzle main body 12 to the back side, the nozzle main body 12 can be positioned at a position at which the positioning recess 17 is engaged with a lower edge of the opening 6 as illustrated in FIG. 5. Accordingly, a reliable fire extinguishing work can be performed even in a case in which the firing source is located at a high position. The firing source can be detected based on variation of voltage and can be displayed on a control panel.

It is preferable to prepare the metallic pipes 13 so that as many metallic pipes 13 as the appropriate number can be sequentially added and used in accordance with the height of the firing source.

Also, the nitrogen gas is supplied from a nitrogen cylinder 21 with source pressure of approximately 15 MPa via a decompression valve to an ejector as illustrated in FIG. 2. The fire extinguishing sand is sucked up from an inside of a tank 22 with negative pressure generated in an inside of the ejector due to this gas stream and is emitted from the nozzle main body 12 along with the gas stream. By using the nitrogen cylinder 21 as a gas source in this manner, an appropriate power source does not need to be found, and the fire extinguishing work can be started immediately.

By using the fire extinguishing nozzle configured as above, in case of fire, the worker can insert the nozzle main body 12 from an end of the flattened upper space 4 formed on the upper surface of the fire extinguishing object to an end portion of the upper surface of the fire extinguishing object and emits the fire extinguishing sand from the tip end portion of the nozzle main body 12 into the upper space 4 by means of gas pressure. Since the fire extinguishing sand can be sprayed obliquely downward by the deflecting plate 16 and be dispersed through the back side while bounding on the upper surface of the fire extinguishing object, the deposited tire extinguishing sand forms the air blocking layer, and reliable fire extinction can be performed.

Although the fire extinguishing object is a module using sodium-sulfur batteries in the foregoing embodiment, the fire extinguishing object is not limited to this, and it is to be understood that the present invention can be widely applied to fire extinction for a fire extinguishing object having a flattened upper space.

### DESCRIPTION OF REFERENCE SIGNS

1 Battery module

2 Rack

3 Floor plate

4 Flattened upper space

5 Door

6 Opening

7 Frame

10 Metallic pipe

11 Fire extinguishing nozzle

12 Nozzle main body

14 Connecting portion

15 Coupling portion

16 Deflecting plate

17 Positioning recess

18 Guide plate

19 Inclined portion

20 Horizontal portion

21 Nitrogen cylinder

22 Tank

1. A fire extinguishing nozzle for emitting fire extinguishing sand uniformly on an upper surface of a fire extinguishing object having a flattened upper space, the fire extinguishing nozzle comprising:
a flattened nozzle main body emitting the fire extinguishing sand by means of gas pressure,
and a deflecting plate, provided at a tip end portion of the flattened nozzle main body, spraying the fire extinguishing sand obliquely downward toward the upper surface of the object and letting the fire extinguishing sand bound.

2. The fire extinguishing nozzle according to claim 1, wherein a lower surface of the flattened nozzle main body is provided with a guide plate having a recess for positioning the nozzle main body.

3. The fire extinguishing nozzle according to claim 1, wherein the deflecting plate has a downward angle of 30 to 45 degrees against the upper surface of the fire extinguishing object.

4. The fire extinguishing nozzle according to claim 1, wherein a base portion of the nozzle main body is bent obliquely downward, and a lower end thereof is provided with a connecting portion to a metallic pipe supplying the fire extinguishing sand by means of the gas pressure.

5. A fire extinguishing method using the fire extinguishing nozzle according to claim 1, comprising:
inserting the nozzle main body from an end of the flattened upper space formed on the upper surface of the fire extinguishing object to an end portion of the upper surface of the fire extinguishing object;
spraying the fire extinguishing sand emitted from the tip end portion of the nozzle main body by means of the gas pressure obliquely downward by the deflecting plate; and
dispersing the fire extinguishing sand through a back side while letting the fire extinguishing sand bound on the upper surface of the fire extinguishing object.

6. The fire extinguishing method according to claim 5, wherein the fire extinguishing sand is vermiculite.
